(19) United States
(12) Patent Application Publication
(10) Pub. No.: US 2013/0153709 A1
(43) Pub. Date: Jun. 20, 2013

(54) PROCESS AND APPARATUS FOR A VEHICLE THAT LEVITATES

(71) Applicant: Henrique Jorge Papadopulos de Sousa, (US)

(72) Inventor: Henrique Jorge Papadopulos de Sousa, (US)

(21) Appl. No.: 13/327,784

(22) Filed: Dec. 16, 2011

(51) Int. Cl. B64G 1/00; B64C 39/00

(52) U.S. Cl. 244/158.1; 244/4 R

(57) ABSTRACT

A levitation system of a vehicle is provided. This system allows a vehicle to levitate and move in all directions. The vehicle can travel in Earth atmosphere. Also this system could be used in space for space travel allowing accelerations never reached before and cover large distances with great autonomy. If a miniaturization of the system is successful, then the system could be applied in a multitude of already existing transport systems, as a complement or as a principal source of movement. Although the purpose of this invention is to levitate and move a vehicle in a three dimensional space, the same system is perfectly applicable to move a vehicle in a two dimension space. The centrifugal force is applied in this system and an internal or external source of energy is necessary to allow the system to operate.

### CROSS-REFERENCES TO RELATED APPLICATIONS

Not Applicable

### STATEMENT REGARDING FEDERALLY SPONSORED RESEARCH AND DEVELOPMENT

Not Applicable

### REFERENCES TO A “MICROFICHE APPENDIX

Not Applicable

### BACKGROUND OF THE INVENTION

1. Field of Invention

The present invention relates generally to levitation of an object, and more specifically, to levitation systems for moving objects in a three dimensional space.

2. Description of Prior Art

Not Applicable

### SUMMARY OF THE INVENTION

It is an object of the present invention to provide a system that levitates a vehicle and can move it in any direction on a three dimensional space. Until now there is no vehicle that can levitate freely with exception to magnetically levitated vehicles with very limited applications. This vehicle defies the force of gravity. Basically this vehicle uses known principles of centrifugal force interaction in order to levitate. The vehicle has a spherical shape. Inside the sphere there is the mechanism that uses the centrifugal force in order to levitate the vehicle. The concept of centrifugal force is applied in rotating devices such as centrifuges, centrifugal pumps, centrifugal governors, etc., as well as in centrifugal railways, planetary orbits, satellite orbits, banked curves, etc.

The centrifugal force mechanism consists in rotating weights in rotational paths mounted the inner wall a sphere. The weights could be propelled by a motor at the middle of the sphere or could be individually propelled with a propulsion system each. Also a magnetic propulsion system could be applied in the rotation paths and in the weights themselves.

The vehicle can be moved and manipulated as described and illustrated in FIGS. 1 trough 20.

### BRIEF DESCRIPTIONS OF THE DRAWINGS

FIG. 1 is a schematic representation of a rotating weight inside a sphere.

FIG. 2 is a schematic representation of the weight circulating horizontally and the acceleration/deceleration half circles.

FIG. 3 is a schematic representation of the centrifugal force exerted against the wall of the sphere.

FIG. 4 is the same as the schematic representation of FIG. 3 with the weight circulating vertically.

FIG. 5 is a schematic representation of the weight circulating horizontally inside the sphere at 100 rotations per minute.

FIG. 6 is the same as the schematic representation of FIG. 5 at 200 rotations per minute.

FIG. 7 is the same as the schematic representation of FIG. 5 at 300 or more rotations per minute.

FIG. 8 is a schematic representation of the weight circulating vertically inside the sphere at 100 rotations per minute.

FIG. 9 is the same as the schematic representation of FIG. 8 at 200 rotations per minute.

FIG. 10 is the same as the schematic representation of FIG. 8 at 300 or more rotations per minute.

FIG. 11 is a schematic representation of the weight circulating horizontally inside the sphere at 100 rotations per minute with a mass of 1 Kg.

FIG. 12 is the same as the schematic representation of FIG. 11 at 100 rotations per minute with a mass of 10 Kg.

FIG. 13 is a schematic representation of the weight circulating vertically inside the sphere at 100 rotations per minute with a mass of 1 Kg.

FIG. 14 is the same as the schematic representation of FIG. 13 at 100 rotations per minute with a mass of 10 Kg.

FIG. 15 is a schematic representation of two rotational paths mounted on the inner wall of the sphere.

FIG. 16 is a schematic representation of four rotational paths mounted on the inner wall of the sphere.

FIG. 17 is a schematic representation of how to change direction horizontally.

FIG. 18 is a schematic representation of how to change direction vertically.

FIG. 19 is a schematic representation of how to change direction vertically and horizontally.

FIG. 20 is a schematic representation of two vertical rotational paths equidistant.

### DETAILED DESCRIPTION OF THE INVENTION

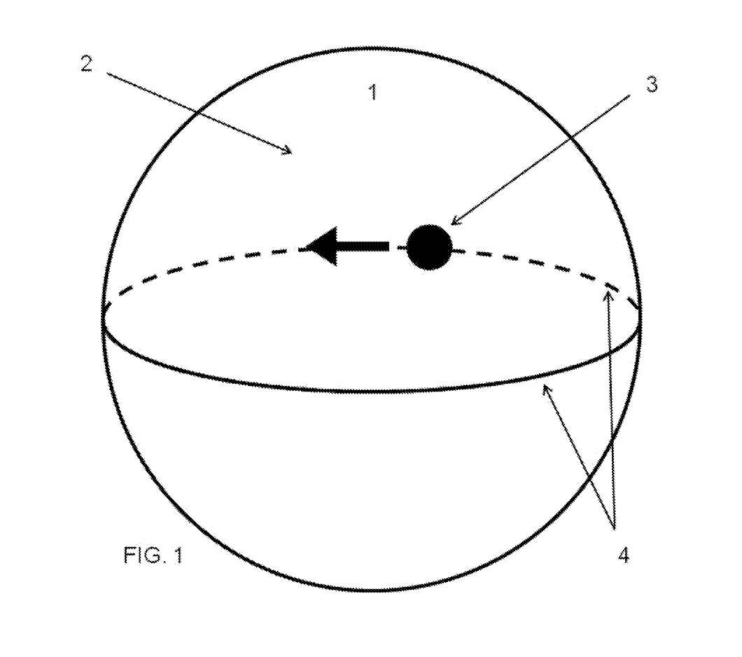

FIG. 1 is a schematic representation of a rotating weight 3 right close to the inside wall of a sphere 2. It shows a rotational path 4 being the largest circumference possible inside the sphere. Being the velocity of the circulating weight constant, no matter the speed, all points in the circumference of the rotating path will receive the same quantity of centrifugal force, not causing the sphere to follow a certain direction. Basically, depending on the velocity of the rotating weight, the sphere will tend to move in all directions.

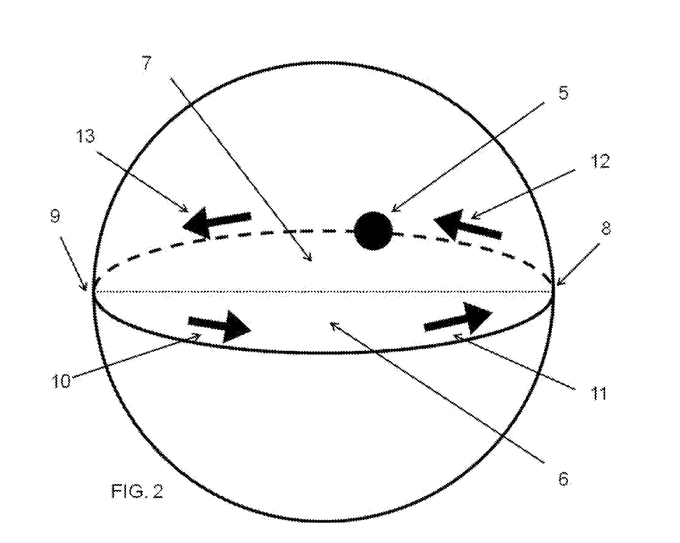

FIG. 2 is a schematic representation of the weight 5 circulating horizontally right close to the inside wall of a sphere. It shows two half circles. One half circle 6 where the weight accelerates and another half circle 7 where the weight decelerates. In point 8 the maximum speed of the weight that circulates is reached. When the weight reaches point 9 it will start its acceleration that culminates in point 8. When the weight reaches point 8 it will start its deceleration that culminates in point 9. The velocity of the circulating weight is not constant. There is a point where the weight starts to accelerate and a point where the weight decelerates. That is here where all the power of this invention resides. The ability to have a specific point in the circumference of the rotation path where the wall of the sphere receives more centrifugal force.

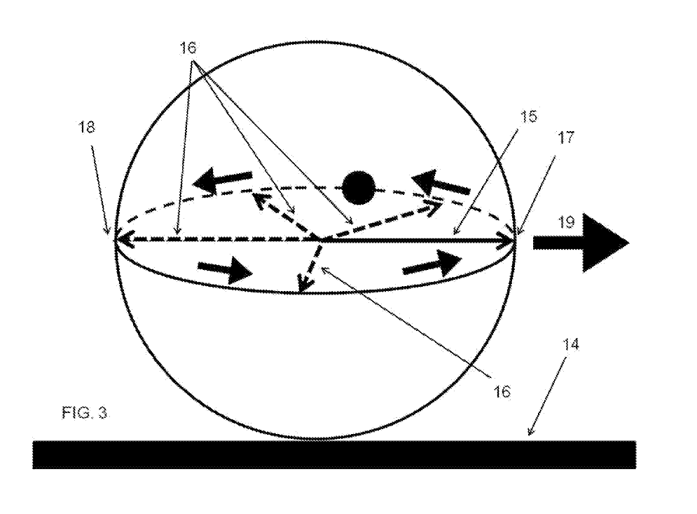

FIG. 3 is a schematic representation of the weight circulating horizontally right close to the inside wall of a sphere. This sphere is on a flat surface 14. The centrifugal force exerted against the wall of the sphere 16 is less than the centrifugal force exerted against the wall of the sphere in vector 15. In point 17 the maximum centrifugal force is exerted against the wall of the sphere. In point 18 the minimum centrifugal force is exerted against the wall of the sphere. When the weight circulates inside the sphere accelerating and decelerating, for each complete turn to the rotational path an impulse in one direction 19 exists where the maximum centrifugal force is exerted against the wall of the sphere. Augmenting the velocity of the circulating weight we can reduce the time between impulses until the centrifugal force applied to a certain point is almost constant. Augmenting even more, the sphere will move in the direction of the point where it receives the impulses.

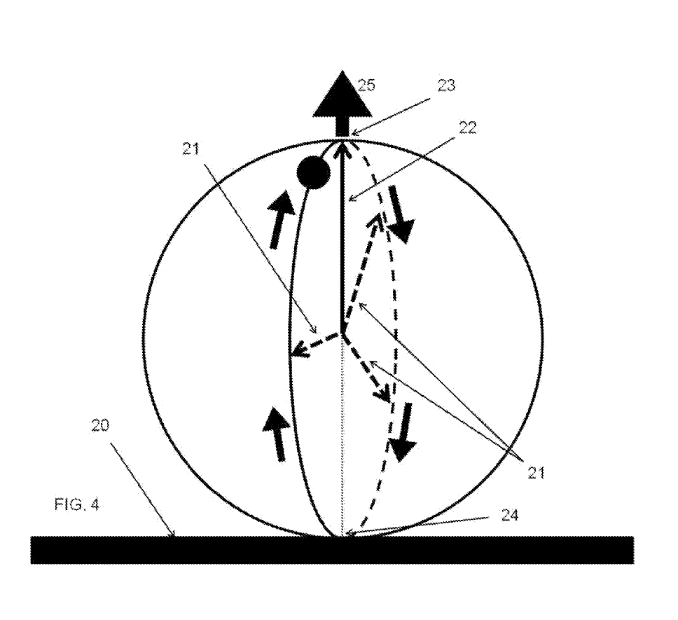

FIG. 4 is a schematic representation of the weight circulating vertically right close to the inside wall of a sphere. This sphere is on a flat surface 20. The centrifugal force exerted against the wall of the sphere in vectors 21 is less than the centrifugal force exerted against the wall of the sphere in vector 22. In point 23 the maximum centrifugal force is exerted against the wall of the sphere. In point 24 the minimum centrifugal force is exerted against the wall of the sphere. When the weight circulates inside the sphere accelerating and decelerating, for each complete turn to the rotational path an impulse in one direction 25 exists where the maximum centrifugal force is exerted against the wall of the sphere. Augmenting the velocity of the circulating weight we can reduce the time between impulses until the centrifugal force applied to a certain point is almost constant. Augmenting even more, the sphere will move in the direction of the point where it receives the impulses.

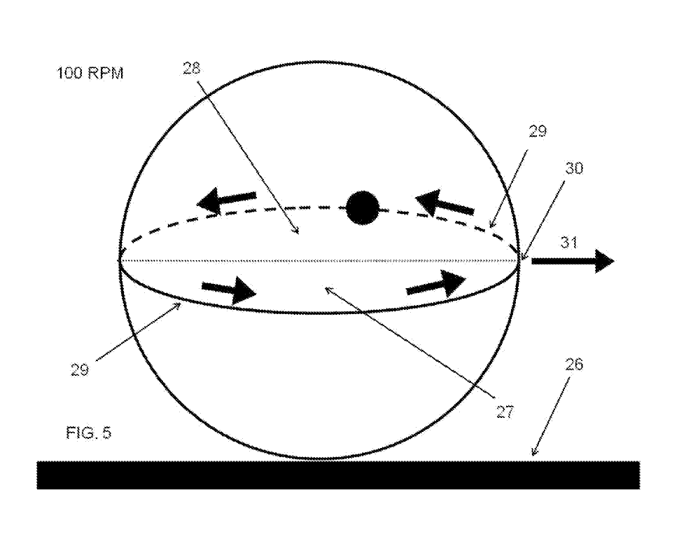

FIG. 5 is a schematic representation of the weight circulating horizontally right close to the inside wall of a sphere at 100 (as an example) rotations per minute 29. This sphere is on a flat surface 26. It shows two half circles. One half circle 27 where the weight accelerates and another half circle 28 where the weight decelerates. While the weight circulates inside the sphere accelerating and decelerating, for each turn, when he reaches its maximum speed in point 30, a stronger impulse in one direction 31 exists where the maximum centrifugal force is exerted against the wall of the sphere.

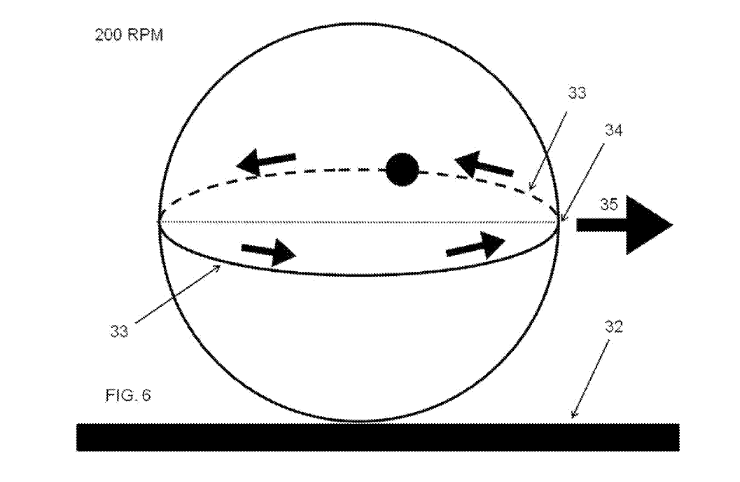

FIG. 6 is a schematic representation of the weight circulating horizontally right close to the inside wall of a sphere at 200 rotations per minute 33. This sphere is on a flat surface 32. While the weight circulates inside the sphere accelerating and decelerating, for each turn, when he reaches its maximum speed in point 34, a stronger impulse in one direction 35 exists where the maximum centrifugal force is exerted against the wall of the sphere. Each impulse in direction 35 is now much stronger then the impulse shown in FIG. 5 at 100 RPM due to the higher rotation speed of the weight.

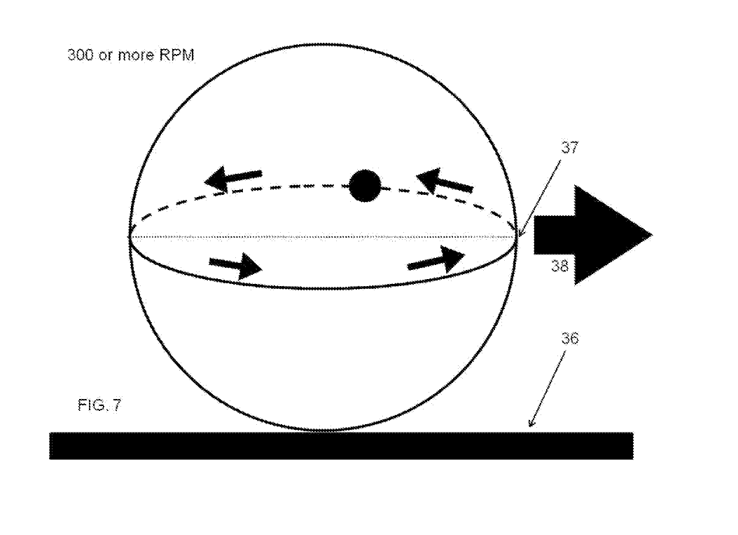

FIG. 7 is a schematic representation of the weight circulating horizontally right close to the inside wall of a sphere at 300 or more rotations per minute. This sphere is on a flat surface 36. While the weight circulates inside the sphere accelerating and decelerating, for each turn, when he reaches its maximum speed in point 37, a stronger impulse in one direction 38 exists where the maximum centrifugal force is exerted against the wall of the sphere. Each impulse in direction 38 is now much stronger then the impulse shown in FIG. 6 at 200 RPM due to the higher rotation speed of the weight.

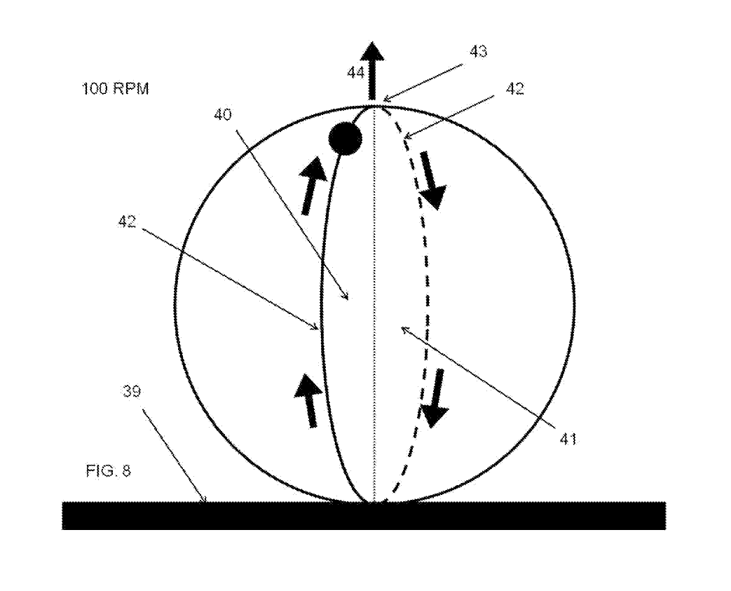

FIG. 8 is a schematic representation of the weight circulating vertically right close to the inside wall of a sphere at 100 rotations per minute 42. This sphere is on a flat surface 39. It shows two half circles. One half circle 40 where the weight accelerates and another half circle 41 where the weight decelerates. While the weight circulates inside the sphere accelerating and decelerating, for each turn, when he reaches its maximum speed in point 43, a stronger impulse in one direction 44 exists where the maximum centrifugal force is exerted against the wall of the sphere.

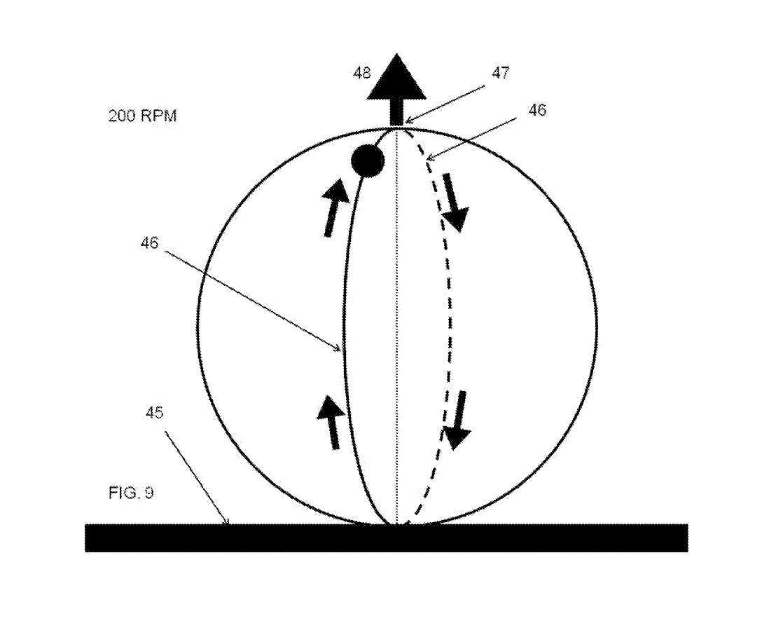

FIG. 9 is a schematic representation of the weight circulating vertically right close to the inside wall of a sphere at 200 rotations per minute 46. This sphere is on a flat surface 45. While the weight circulates inside the sphere accelerating and decelerating, for each turn, when he reaches its maximum speed in point 47, a stronger impulse in one direction 48 exists where the maximum centrifugal force is exerted against the wall of the sphere. Each impulse in direction 48 is now much stronger then the impulse shown in FIG. 8 at 100 RPM due to the higher rotation speed of the weight.

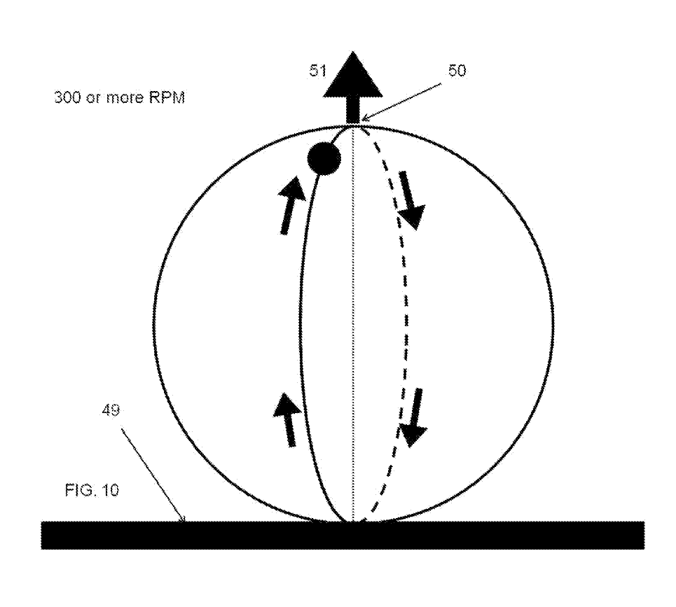

FIG. 10 is a schematic representation of the weight circulating vertically right close to the inside wall of a sphere at 300 or more rotations per minute. This sphere is on a flat surface 49. While the weight circulates inside the sphere accelerating and decelerating, for each turn, when he reaches its maximum speed in point 50, a stronger impulse in one direction 51 exists where the maximum centrifugal force is exerted against the wall of the sphere. Each impulse in direction 51 is now much stronger then the impulse shown in FIG. 9 at 200 RPM due to the higher rotation speed of the weight. Continuing augmenting the velocity of rotation, there will be a point that the force applied in the point 50 will be superior to the gravitational force of the mass of the whole sphere making the sphere leave the surface and starting levitation.

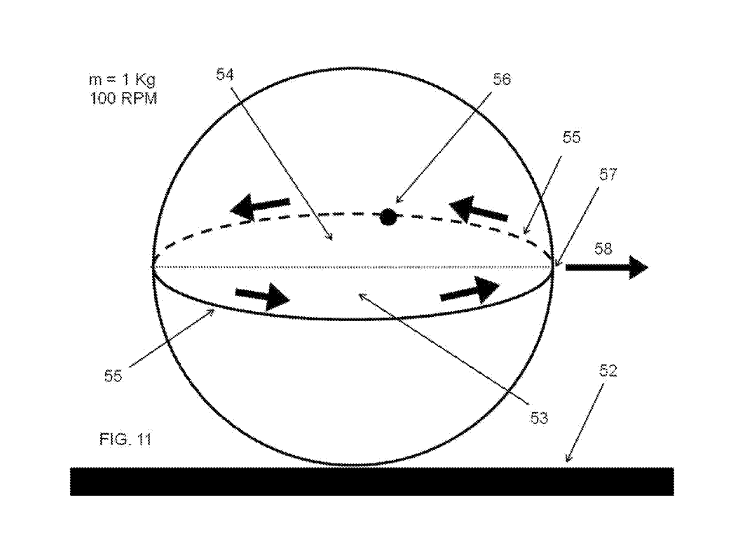

FIG. 11 is a schematic representation of the weight 56 circulating horizontally right close to the inside wall of a sphere at 100 rotations per minute 55 with a mass of 1 Kg. This sphere is on a flat surface 52. It shows two half circles. One half circle 53 where the weight accelerates and another half circle 54 where the weight decelerates. While the weight circulates inside the sphere accelerating and decelerating, for each turn, when he reaches its maximum speed in point 57, a stronger impulse in one direction 58 exists where the maximum centrifugal force is exerted against the wall of the sphere.

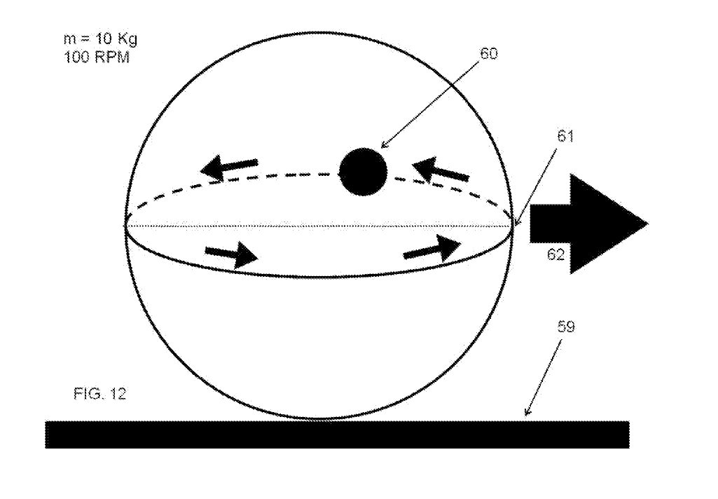

FIG. 12 is a schematic representation of the weight 60 circulating horizontally right close to the inside wall of a sphere at 100 rotations per minute with a mass of 10 Kg. This sphere is on a flat surface 59. While the weight circulates inside the sphere accelerating and decelerating, for each turn, when he reaches its maximum speed in point 61, a stronger impulse in one direction 62 exists where the maximum centrifugal force is exerted against the wall of the sphere. Each impulse in direction 62 is now stronger then the impulse shown in FIG. 11 at 100 RPM due to the higher mass of the weight.

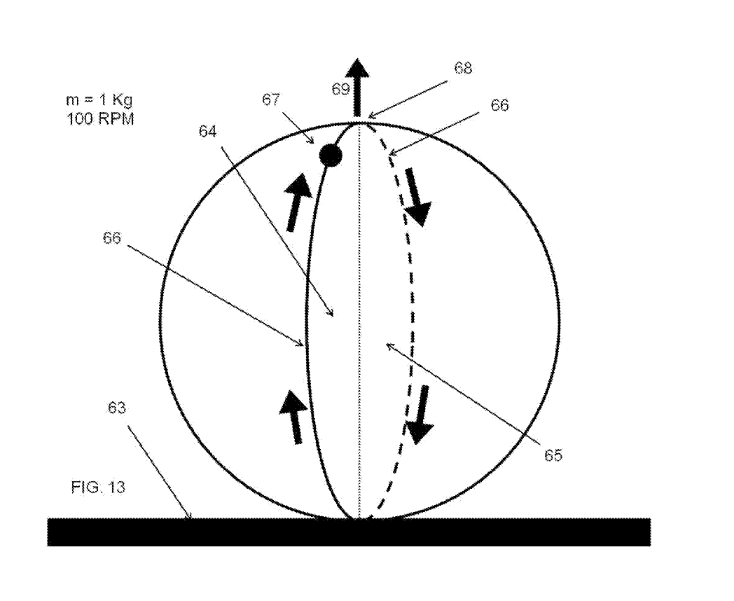

FIG. 13 is a schematic representation of the weight 67 circulating vertically right close to the inside wall of a sphere at 100 rotations per minute 66 with a mass of 1 Kg. This sphere is on a flat surface 63. It shows two half circles. One half circle 64 where the weight accelerates and another half circle 65 where the weight decelerates. While the weight circulates inside the sphere accelerating and decelerating, for each turn, when he reaches its maximum speed in point 68, a stronger impulse in one direction 69 exists where the maximum centrifugal force is exerted against the wall of the sphere.

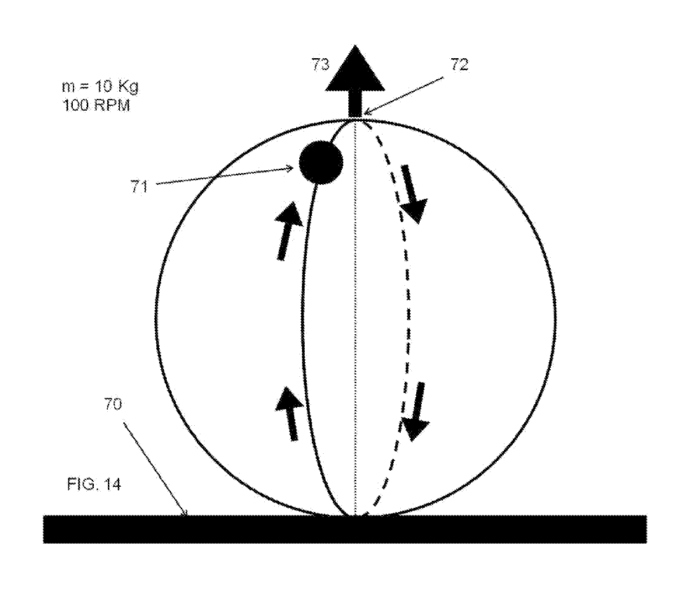

FIG. 14 is a schematic representation of the weight 71 circulating vertically right close to the inside wall of a sphere at 100 rotations per minute with a mass of 10 Kg. This sphere is on a flat surface 70. While the weight circulates inside the sphere accelerating and decelerating, for each turn, when he reaches its maximum speed in point 72, a stronger impulse in one direction 73 exists where the maximum centrifugal force is exerted against the wall of the sphere. Each impulse in direction 73 is now stronger then the impulse shown in FIG. 13 at 100 RPM due to the higher mass of the weight.

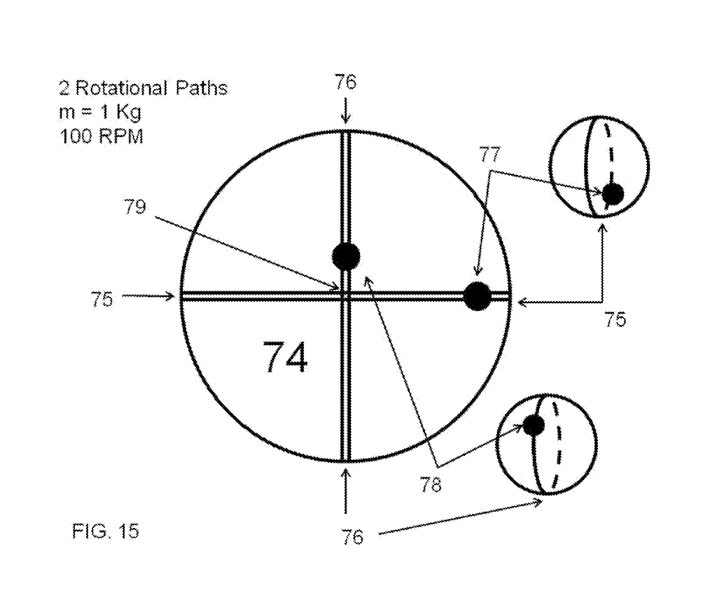

FIG. 15 is a schematic representation of two rotational paths 75, 76, mounted on the inner wall of the sphere. It shows the sphere from a top perspective 74. Two weights are circulating vertically right close to the inside wall of a sphere at 100 rotations per minute with a mass of 1 Kg. The two weights are synchronized in a way that if one of the weights is passing by point 79 and starting his deceleration, the other weight almost starting his acceleration. While the weights 77, 78, circulates inside the sphere accelerating and decelerating, for each turn, when they reaches its maximum speed in point 79, a stronger impulse exists where the maximum centrifugal force is exerted against the wall of the sphere.

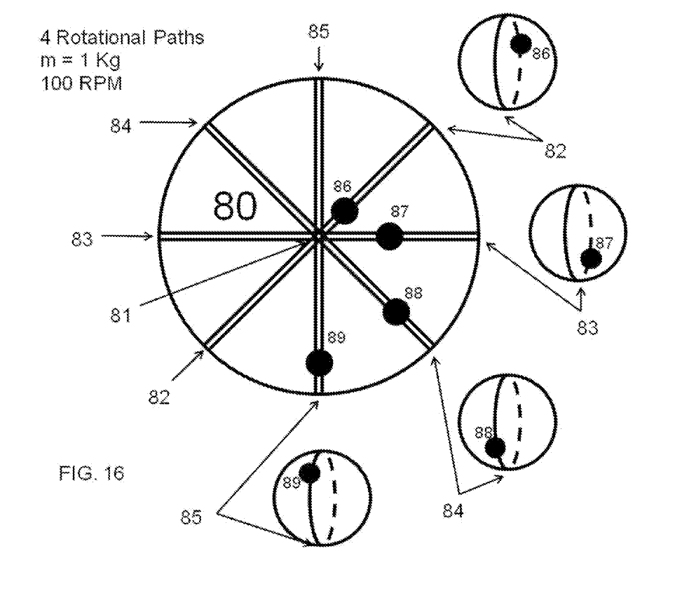

FIG. 16 is a schematic representation of four rotational paths 82, 83, 84, 85, mounted on the inner wall of the sphere. It shows the sphere from a top perspective 80. Four weights are circulating vertically right close to the inside wall of a sphere at 100 rotations per minute with a mass of 1 Kg. The four weights are synchronized in a way that if one of the weights is passing by point 81 and starting his deceleration, the other weight almost starting his acceleration. While the weights 86, 87, 88, 89, circulates inside the sphere accelerating and decelerating, for each turn, when they reaches its maximum speed in point 81, a stronger impulse exists where the maximum centrifugal force is exerted against the wall of the sphere. The sphere shown here with four rotational paths will have the double of impulses in point 81 for the same period of time then sphere with two rotational paths shown in FIG. 15. As the number of rotations paths increase, the necessary velocity of rotating weights decrease. The system can have two, three, four, five, six or more rotation paths.

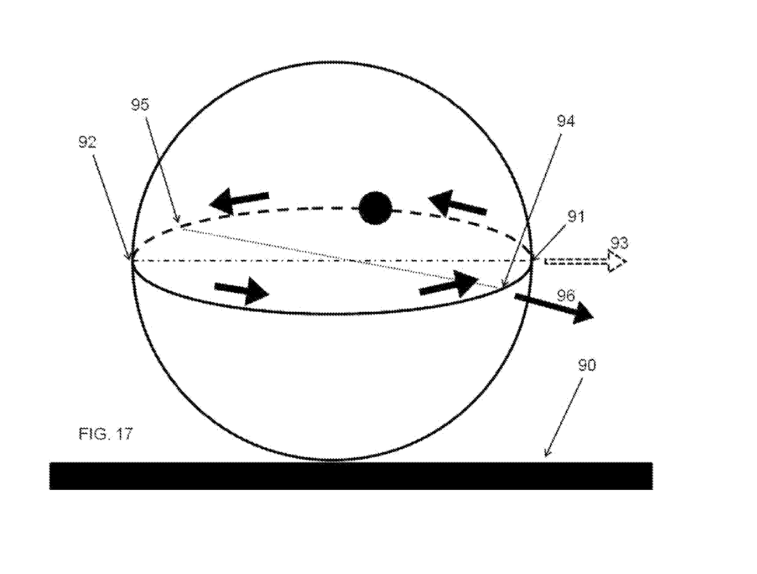

FIG. 17 is a schematic representation of how to change direction horizontally. This sphere is on a flat surface 90. In order to change direction, the half circle where the weight accelerates and another half circle where the weight decelerates should be displaced. To change the accelerating half circle, the beginning of acceleration of the weight should be changed from point 92 to point 95. This makes that for the decelerating half circle the beginning of deceleration of the weight will be point 94 where before it was point 91. While the weight circulates inside the sphere accelerating and decelerating, for each turn, when he reaches its maximum speed in point 94, a stronger impulse in direction 96 exists where before the stronger impulse existed in point 91, in direction 93.

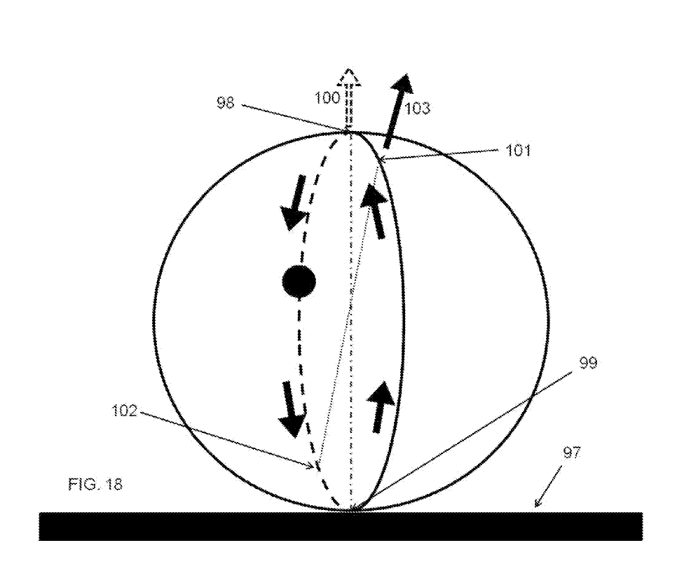

FIG. 18 is a schematic representation of how to change direction vertically. This sphere is on a flat surface 97. In order to change direction, the half circle where the weight accelerates and another half circle where the weight decelerates should be displaced. To change the accelerating half circle, the beginning of acceleration of the weight should be changed from point 99 to point 102. This makes that for the decelerating half circle the beginning of deceleration of the weight will be point 101 where before it was point 98. While the weight circulates inside the sphere accelerating and decelerating, for each turn, when he reaches its maximum speed in point 101, a stronger impulse in direction 103 exists where before the stronger impulse existed in point 98, in direction 100.

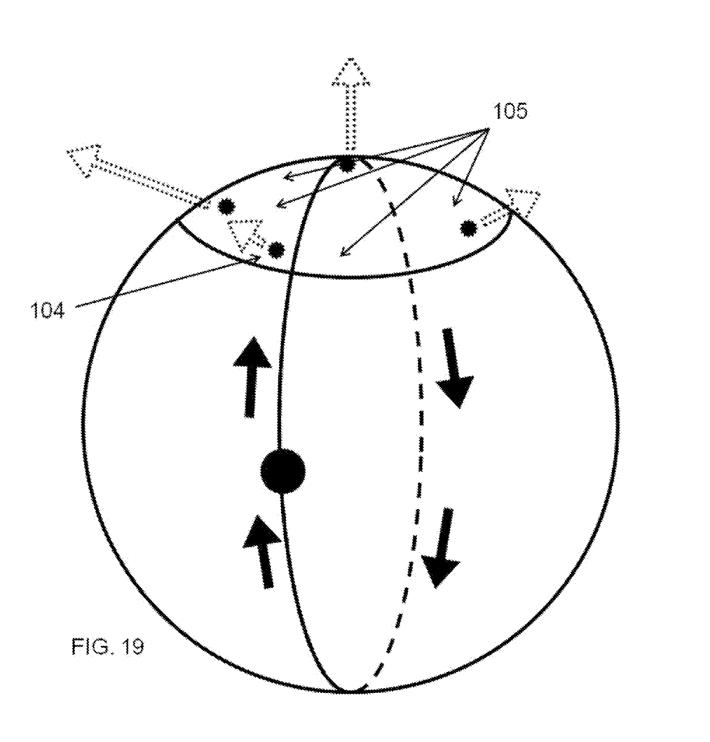

FIG. 19 is a schematic representation of how to change direction vertically and horizontally. In order to change direction vertically and horizontally, the method of changing direction displacing half circles of acceleration/deceleration shown in FIG. 18 can be used. Point 104 is just an example of a multitude of points, in area 105 that can be used to receive the stronger impulses, in order to go to a direction vertically and horizontally.

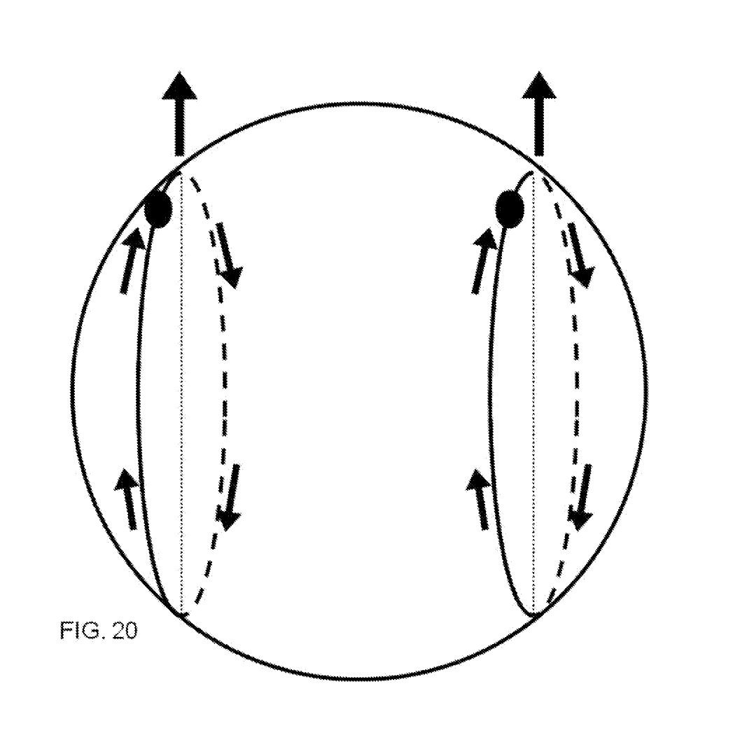

FIG. 20 is a schematic representation that shows two vertical rotational paths equidistant where the weights circulates in a synchronous way. The advantage is this disposition of rotational paths will give more stability to the levitating sphere.

The above results do not represent optimum values, but are given simply to illustrate the principles of the invention.

Changes and modifications in the specifically described embodiments can be carried out without departing from the scope of the invention, which is intended to be limited by the scope of the appended claims.

I claim:

1. An levitating vehicle, the vehicle having:
an spherical shape with an inside rotating mechanism composed of weights circulating vertically and horizontally, accelerating and decelerating in half-circles, right close to the inside wall of a sphere;
an set of rotational paths mounted on the inner wall of the sphere where the weights circulates;
an internal or external source of power generation for moving the circulating weights.

2. An vehicle according to claim 1 in which:
the force generated in order to levitate itself is used as well to move the vehicle in a three dimensional space, being in atmosphere or in space;
the speed of movement in one direction is proportional to the mass of weights, moving speed of circulating weights, number of rotational paths, and total payload of the system.
